(19) United States
(12) Patent Application Publication
(10) Pub. No.: US 2006/0007059 A1
(43) Pub. Date: Jan. 12, 2006

(54) Flexible display screen arrangements and applications thereof

(76) Inventor: Jonathan Arnold Bell, Culver City, CA (US)

Correspondence Address: Jonathan Arnold Bell, 5314 South Siauson Avenue, Cluver City, CA, 90230, US

(21) Appl. No.: 11/152,125

(22) Filed: Jun. 14, 2005

Related U.S. Application Data
(60) Provisional application No. 60/585,503, filed on Jul. 6, 2004.

(51) Int. Cl. G09G 3/20

(52) U.S. Cl. 345/55

(57) ABSTRACT

This document describes the design and control of a flexible, electronic display screen mechanism. The display may emit, reflect, or otherwise control visible and invisible light such that a viewer may see graphical shapes, text based characters, or time varying images on the screen. The flexibility of the display screen allows it to be physically bent, curved, wrapped, or molded without causing breakage or otherwise deteriorating the performance of the device. This flexibility allows these displays to be used, for example, within items of clothing.

### CROSS-REFERENCE TO RELATED APPLICATIONS

Provisional Patent Application 60/585,503.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

Not applicable.

### BACKGROUND OF THE INVENTION

The past one hundred years have produced many different types of electronic display screen. Typically these screens use electrical signals to generate an array of Illuminations viewable by the human eye. The display screens may show graphical representations, animations, moving picture images such as video, or alpha-numeric characters such as text.

Some of the earliest screens were constructed of many separate electrical light bulbs. Later technical advances introduced the cathode ray tube, still commonly used today in television screens, and liquid crystal displays, commonly used today as computer screens. Nearly all the previously developed screen types have been rigid in structure such that they cannot be bent around a curved surface without breaking. More recently, screens based on electro-luminescent technology, liquid crystals, and organic/polymer light emitting diodes have allowed for a degree of flexibility whilst maintaining operational integrity. The flexible display screen arrangements discussed here include flexible display screens and associated electrical circuits that are Interconnected with flexible electrical wiring that allow the screen arrangements to flex and bend over a three dimensional surface. Two essential components in these screens are flexible circuit board material and low profile surface mount light emitting diodes (LEDs).

Previous authors have outlined numerous methods for constructing flexible screens. Erickson (U.S. Pat. No. 6,511,198) discusses the use of Light Emitting Polymers (LEPs) imprinted onto cloth, Ota (U.S. Pat. No. 6,490,402) introduces a woven structure of thread-like LEDs, Wainwright et al (U.S. Pat. No. 6,217,188) show fiber-optic threads used as point sources of light, Kiryuschev et al (U.S. Pat. No. 6,072,619) implement a woven structure of thread-like Electro-Luminescent devices (EL), Yei et al (U.S. Pat. No. 6,116,745) outline a flexible EL backlight panel being used to illuminate a logo and other indicia, Nadel et al (U.S. Pat. No. 5,577,828) demonstrate a single LED being used to illuminate a logo and other indicla, Daniel (U.S. Pat. No. 4,234,907) puts forward a woven structure of fiber-optic threads, and Atchinson et al (U.S. Pat. No. 6,371,637) describes a flexible length of illumination based on flexible circuit board material and LEDs. What is new about this invention is the use of flexible circuit board material with low profile surface mount light emitting diodes (LEDs) combined with a row-column electrical addressing scheme. The row-column addressing scheme allows each LED to be individually activated whilst minimizing the number of electrical connections that need to be made to the LEDs.

### OBJECTS OF THE INVENTION

One object of the present invention is to provide a device for allowing the illuminated display of graphics and alpha-numeric characters whilst being able to be flexed, bent, wrapped, or molded within or around a non-flat three dimensional surface.

A further object of the invention is to show how the illuminations shown on the screens can be controlled using a combination of microcomputer circuit, electrical push-button inputs, and external environmental stimuli, e.g., audio microphone inputs.

A further object of the invention is to show how control information may be passed to the screen microcomputer(s) via other devices such as personal computers, personal digital assistants, mobile telephones, or other electronic digital devices.

A further object of the invention is to show how these illuminated screens may be Interconnected so that the individual screens may be placed within items of clothing without the electrical circuits and the Interconnecting wire cables being apparent to the viewer. Only the illuminations shine through the cloth of the garments.

A further object of the Invention is to provide for a means to interconnect a large number of these screens over a large area such that the individual screens become smaller parts of an overall large screen.

A further object of the invention is to provide a means for wireless telephony connection between screens and a computer server so that information may be transmitted from the server to the screen for display purposes.

### BRIEF SUMMARY OF THE INVENTION

The flexible display screens described here are constructed of conductive flex-circuit fabricated from a suitable non-conductive flexible sheet form body such as polyimide (Kapton™) clad in a thin film of suitable conductive material such as copper; solder paste or other suitable materials such as conductive epoxy, surface-mount resistor and capacitor components, surface-mount light emitting diodes (LEDs) that act as pixels, surface-mount transistor based components such as LED multiplexor drivers and microcomputer units (MCUs), surface-mount mechanical/electrical connector wire assemblies, and a flexible protective coating material.

The conductive flex circuit has a pattern of electrical traces made on its surface to represent the electrical circuit using industry standard techniques such as photolithography. Solder paste (or other suitable material) is then applied to the flex circuit where an electrical and/or mechanical bond is required. All electronic surface-mount components may then be placed on top of the paste deposits. The metal content of the solder paste is melted, or re-flowed, and then cooled by passing the entire circuit assembly through a heated oven giving a solid mechanical/electrical bond of all components to the copper flex circuit. For typical flex circuits that require two or more layers of interconnecting electrical traces, connections are made between layers using small holes (vias) filled with conductive material.

The pixels that can be made to light up or otherwise change their transmission and/or reflective qualities are electrically controlled by an LED multiplexor driver integrated circuit. This circuit typically determines which LEDs are on (active) or off at any given time. To reduce the number of interconnecting conductive traces required on any given circuit, the LED multiplexor can drive the pixel screen in a row-column matrix format. Each row of the matrix is accessed in turn by the electronics within the multiplexor and the appropriate LEDs in that row are turned on. Then these LEDs are turned off and the multiplexor accesses the next row of the screen. The multiplexor accesses the rows of the screen at a speed that is faster than the human eye can detect and so the overall appearance is of a screen that is continually lit with the desired Image. A suitable multiplexor for this purpose is the Texas Instruments TLC5920. It is also possible to add memory elements such as transistors at each pixel, or LED, location so that the persistence of the human eye is no longer required to provide an image free of flicker.

The LED multiplexor is itself typically controlled by another digital electronic circuit called a microcomputer unit (MCU). This is a small digital processor chip that may be programmed with software to output the necessary electrical signals to the LED multiplexor to achieve the desired optical picture on the screen. Having an MCU and an LED multiplexor considerably increases the operational variety with which the screens may be used. The LED multiplexor relieves the MCU from many mundane tasks such as the regular lighting of all necessary pixels on the screen thus allowing the MCU to concentrate on more user related calculation routines such as button push Interfacing, audio input processing, and external communication from other digital devices such as mobile phones. At the same time, the LED multiplexor is typically designed to manage higher electrical current and/or electrical voltage values that most MCU units and so can be used to drive screens larger and brighter than a stand alone MCU.

Programming the MCU with the basic operating computer code to run the LED multiplexors, button inputs and other functions may be achieved by linking to an external personal computer which has the necessary programming software installed. The operating computer code is known as the operating system and determines how the MCU shall behave after it has been electrically switched on.

Once programmed, the MCU can be used to accept input electrical signals such as on/off button pushes and external environmental stimuli such as analog audio signals. As an example, the user may change the behavior of the display and its visual content by simply pushing a button causing the MCU to switch to a different control mode. Audio signals from the surrounding environment may be used as inputs to the MCU using a microphone connected to the MCU analog-to-digital converter (ADC). Measurement of incoming amplitude, frequency, or power spectrum allows the microcomputer to alter the contents of the visual display in response to the incoming signal. Examples are, but not limited to, increasing and decreasing the number of pixels lit up on the display, increasing and decreasing display brightness and color, changing direction of illumination on the display, changing speed of movement of illumination on the display etc. A suitable MCU for this purpose is the Renesas H8 series.

For transducers such as audio microphones, optical detectors, radio antenna etc, the strength of the received signal on the MCU is typically a function of the strength of signal present in the surrounding environment and this signal strength may vary over a wide range. To compensate for high or low signal strength, a variable amplifier circuit is typically used. For a variable amplifier circuit to remain waterproof it may need to be encased in a watertight material and this makes it difficult to use variable analog potentiometers that typically have awkward moving parts Involved such as a thumb wheel or slider. This issue can be overcome by using a digital potentiometer controlled through waterproof momentary switches that are less awkward to use.

The MCU can also be used to accept input electrical signals such as those from an external computer, mobile phone, or personal digital assistant (PDA). Here, the external connecting device may be used as an interface between the human user and what the flexible display panel shows. For example, a PDA can be used to input a text message from a user using the PDA keypad. Using suitable software designed for the PDA, the text message can then be electrically transferred to the MCU via a set of wires and a suitable exchange protocol such as RS232. Alternatively infra-red (IR) connection between the PDA and MCU can be achieved using IR transmitters and detectors with a suitable exchange protocol such as ‘IRCOMM’. A further wireless alternative might use ‘Bluetooth’ technology or similar. Possible uses are, but not limited to, input of text to the microcomputer and display screen, input of graphics, animations, or downloading of new operating system computer code to the microcomputer.

The display panels may now be controlled remotely, from a distance, without wire connections, so it is now possible for another user to transmit Information to the display screen. To prevent unsolicited messages from being displayed on the screens, it is desirable to include a privacy option. Examples of this privacy option are a user button as part of the display assembly that switches between receive and do not receive modes. Alternatively a multitude of available receive channels may be available within the display MCU such that the MCU will only process received signals that used the same channel number as the channel number currently set within the MCU. A third example would use an individual identification (ID) number input by the user. Any received signals that do not match the ID number will not be displayed. This application is useful for public gatherings where an audience may be conducted like a ‘light’ orchestra lighting up individuals on a one-by-one basis, or in advertising applications where shops narrowcast a wireless signal from within their premises alerting potential customers to sales items etc. A corollary to the unique ID number is a master control circuit that may override all unique ID numbers such that all screens within proximity to the master control circuit are under its control.

The circuit is electrically powered using a set of small batteries. Alternatively, the circuit can be powered by any suitable direct current (d.c.) supply.

Reliability of the flexible display screens can be increased through various aspects of the mechanical/electrical circuit design. By cutting holes in the layers of the flexible display circuit where no components, electrical vias, or electrical traces are present, the screen obtains greater flexibility. Similarly, thin strips of LEDs arranged in a horizontal-vertical array structure, and electrically connected at the row-column cross-points to form a screen will have improved flexibility. To minimize the risk of electrical circuit failure because of a broken electrical trace caused through repeated flexing of the screen, the trace connecting each LED within the screen can be made of multiple traces. If one trace breaks, the others maintain correct operation. To minimize the risk of electrical circuit failure because of a broken electromechanical joint between an Integrated circuit, or other electrical component, and the electrical traces on the screen circuit, stacked layers of flexible materials can be arranged underneath, on top, and/or around the electronic components. These stacked layers distribute any stresses caused by flexing away from the sensitive electromechanical joint areas giving greater reliability to the overall flexible display screen.

Once the entire circuit(s) have been fabricated, programmed, and tested, each separate part of the circuit is coated in a protective material that serves a multi-functional purpose. This material can be a silicone or other suitable substance that can be poured onto the circuit and then cured in air or uses a catalyst to promote solidification/curing. The protective coating material allows the Internal electrical circuits to remain mechanically flexible so that they can bend, it prevents water from coming into direct contact with the electrical circuit and components (waterproofing), it prevents the surrounding environmental air from coming into direct contact with the electrical circuit and components which can cause corrosion of electrical traces and other types of circuit damage, and gives the electrical circuit and components an additional mechanical strength, particularly around each individual component.

The coating material may also be used to define column and other shaped structures over each pixel area of the display screen. These shaped structures may be used to act as refractive lenses, focusing emitted or reflected light to a certain point at a certain distance from the screen, and as reflective elements that couple as much of the emitted or reflected light to the normal output plane of the display screen. By shaping the structures to some other cross-sectional shape from circular, it is possible to make each pixel appear as though it were heart-shaped, or Irish-clover shaped, to give two examples.

With a completed flexible display screen it is now possible to use as a stand-alone unit, possibly wrapped around a curved surface, or install it inside an item of clothing, for example, a jacket. One method for attaching the display screens into clothing is to use the same coating material described above. By applying a thin layer to the surface of the screen and then applying the screen to the cloth, a permanent bond can be achieved without detracting from the coating material features named above. It also allows the cloth/screen combination to retain flexibility. Columns formed above each pixel of the display screen can help add impact resistance to the screen and associated circuitry by forming air pockets between the outer cloth of a garment and the screen itself.

A second method of attaching the display screen to the cloth of the garment is to have a pouch or pocket made that will hold the display screen in proximity to the outer cloth of the garment. The pouch cannot typically be seen from the outside of the garment as it resides in the lining of the garment. The screen is inserted between the pouch and outer cloth of the garment. A third method is to use pressure sensitive adhesive tape between the screen and the garment cloth.

Cloth typically has a grain structure inherent in the weave of the fabric. This means that the cloth can be somewhat more elastic in one direction (defined here as x direction) as opposed to the opposite direction (defined here as y direction). To minimize any additional stiffness added to the screen as a result of it becoming part of the cloth assembly, it is advisable to align the direction of maximum screen flexing with the most elastic direction of the fabric. Overall knowledge of the cloth weave allows the flexibility of the final cloth/screen assembly to be controlled by choosing the direction with which the cloth is aligned to the screen.

Cloth may also act as an optical diffuser for any emitted/reflected light coming from the display underneath the cloth. The weave of the fabric and structure of the yarn can be chosen to give a desired diffusion effect. A densely woven fabric of high thread count will typically diffuse more than a loosely woven fabric of low thread count. The weave may also be used to control the amount of light transmission through the cloth. A densely woven fabric of high thread count will transmit less than a loosely woven fabric of low thread count.

Cloth may also be dyed in different colors, or have its color permanently changed by some other technique, to promote or deter certain optical effects. For maximum transmission of visible light through fabric of a given weave, white is the color of choice. To minimize the transmission of visible light through the same fabric of a given weave, black is the color of choice. By choosing gray colors and lighter/darker shades of all the other colors, the amount of light that any single screen pixel is allowed to transmit through the cloth above it may be controlled.

Selective use of colored dyes and pigments may also be used in the cloth to define single pixel areas where the viewer can expect a dot of light to appear or not. For example a white pixel area surrounded by a black border defines a framed area. This technique may be used to define a grid like appearance on the cloth that defines where the screen matrix is located. This allows the viewer to assess where the screen area is defined and where lights will appear if and when they are switched on. Colored dyes and pigments In the cloth can also be used to define other graphically shaped pixel frames such as heart-shaped, clover shaped etc.

Use of colored dyes and pigments in the cloth can also act as selective color filters for any light that is emitted or reflected from underneath the cloth. For example a white light shining through a red dyed cloth will appear red to the viewer. This technique allows the cloth to be used as a color filter for light coming from underneath the cloth. By using phosphorescent and/or luminescent dyes and pigments in the cloth, lights of a lower wavelength impinging on the dye from beneath or above the cloth may be used to excite higher wavelengths of light from the dye, which is then emitted outward from the cloth toward the viewer. For example an ultra-violet light shining on a phosphorescent and/or luminescent substance may permit a range of visible colors to be emitted.

Clothing typically conforms to the body shape in some way, partly through the different pattern shapes the cloth is cut into to construct the garment and partly through the drape of the cloth. Clothes typically bend and fold as necessary rather than being rigid. To ensure that a garment fitted with flexible display screens does not appear unsightly to the human eye, it is important that the circuits and connecting wires that lie beneath the outer cloth are placed in strategic positions so as to minimize any visibility from outside.

When multiple wires are used as interconnections between electrical circuits it is beneficial to use a multitude of single cable wires rather than a multi-core cable. Flat ribbon cable, round cable, or flex cable, are typically undesirable as they tend to show lines through the outer cloth due to a certain amount of stiffness. Using single cable wires where each cable is made up of many individual strands of thinner wire helps greatly with the ability of the cable wire to hang loose and drape naturally behind the outer garment cloth, without external visual evidence of it being there. Henceforth a cable will refer to a single electrical interconnection made of multiple wire strands and covered with an electrically insulating material that prevents electrical shorting between individual cables.

In some screen circuits where an MCU is resident on each screen, it is possible to reduce the number of interconnecting cables transmitting digital signals between screens to one or two Interconnecting cables instead of many. This can be achieved by using digital transfer protocols such as RS232 to transmit and receive data between the MCU screens. Reducing the number of cables that interconnect circuits helps reduce weight and bulk. Wireless transmitters and receivers embedded Into circuits can further reduce the required number of Interconnecting cables.

Use of digital protocols such as RS232 can also help in the fabrication of large scale screens made up of smaller individual screens. In this case many smaller screens are tiled together to form a much larger screen area. Each smaller screen MCU is daisy chained together on a wired or wireless digital signal bus, for example a transmit and receive RS232 protocol standard. The operating system within the MCU of each small screen receives the entire signal, extracts the appropriate data for its screen area, and then controls the pixels of its screen accordingly by communicating with the smaller screen multiplexor(s). The MCU of each smaller screen also re-transmits the entire incoming RS232 signal to the next screen on the daisy chain. In this way the RS232 digital signal is regenerated at each smaller screen allowing the digital signal integrity to be maintained across the entire tiled screen area. In this way It may be possible to tile large areas such as sports stadiums, dance halls, building sidings etc. Each small individual screen must have some method to extract only the information contained in the signal that is appropriate to that particular screen. One example is to identify the screen with a particular number that is hardwired onto the circuit by use of a series of open and closed switches. The open and closed state of these switches can be read by the MCU of the small screen through an input port. A second example is to place a particular number in each MCUs' operating software when it is burned in at the factory. A third example is to burn a particular number into each of the smaller screens once they are all assembled into the larger area screen. This would be done via the daisy chained digital signal bus.

It may also be desirable to have large area screens made up of smaller area screens where each smaller screen MCU is wirelessly linked to the Incoming digital signals. For example at a sports arena where individual members of the crowd represent the smaller area screens and the crowd collectively make up the large area screen. In this case it is more convenient for each person to receive digital control signals without having to wire themselves to a neighbor or some other, fixed wired connection. Connection through a wireless network such as a wireless telephony system would be appropriate. Each individual may dial up a telephone number and input the seating or standing area they are located in, sometimes indicated by their ticket number. An internet linked computer server communicating with each individual phone can then compute the appropriate digital data to send to each wireless phone. Each phone can then relay the digital data through a wired interface to the individuals' small screen or through a wireless interface such as ‘Bluetooth’.

A wireless telephony link also allows a screen, small or large, to be linked to an internet computer server so that messages can be transmitted to the screen at any time whilst communication is maintained. This might be useful for updating information such as sports scores, news and weather items, financial data etc on the screen(s). Either a user may establish a connection for data download, or if the screen is located at a remote site, the screen may be dialed up and a link established.

### BRIEF DESCRIPTION OF THE SEVERAL VIEWS OF THE DRAWING

FIG. 1 shows a top view representation of a flexible display screen.

FIG. 2 shows a top view representation of a flexible display screen with holes.

FIG. 3 shows a top view representation of a flexible display screen with redundant electrical traces.

FIG. 4A shows a top view representation of a flexible display screen with multiple stacked layers of flexible materials.

FIG. 4B shows a cross-section on I-I of FIG. 4A.

FIG. 5A shows a top view representation of a flexible display screen that has been coated and/or molded with a protective, flexible material.

FIG. 5B shows a cross-section on I-I of FIG. 5A.

FIG. 5C shows a cross-section on II-II of FIG. 5A.

FIG. 6 shows a side view representation of a flexible electrical circuit where a protective, flexible material is used to cover and waterproof momentary electrical push buttons.

FIG. 7 shows a top view representation of a patterned cover material that can be placed over the flexible display screen.

FIG. 8 shows a perspective view representation of a flexible display screen overlaid with a patterned cover material.

FIG. 9 shows two top view photographs of a flexible display screen with and without a cloth overlay.

FIG. 10 shows a perspective view representation of two flexible display screens, associated control circuits, and power supply.

FIG. 11 shows a top view representation of the cloth patterns required for a jacket torso and arms.

FIG. 12 shows a perspective view representation of a snap fit connector and interconnect cable wiring assembly.

FIG. 13 shows a top view representation of a jacket inside lining and inside pocket.

FIG. 14 shows a photograph of an illuminated jacket using a front and rear flexible display screen.

FIG. 15 shows a top view representation of the position of momentary electrical switches underneath the jacket cloth.

FIG. 16 shows a perspective view representation of two flexible display panels daisy-chained together.

### DETAILED DESCRIPTION OF THE INVENTION

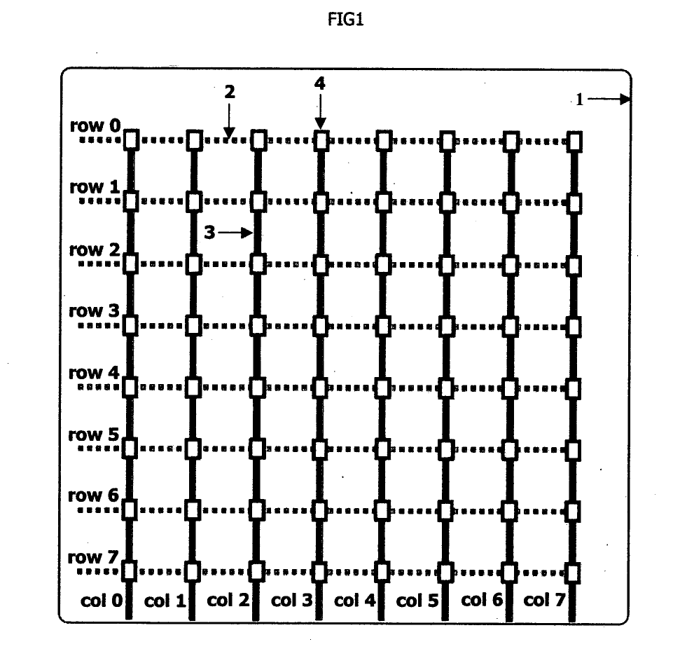

FIG. 1 shows a top view representation of a flexible display screen constructed of a flexible electrical circuit 1, electrically defined row traces 2, and column traces 3, that interconnect with surface mount LEDs 4. Row traces and column traces are located on opposite sides of the circuit board and are connected through electrical vias. Typical operation of the screen occurs in the following manner: row 0 will be activated by the LED multiplexor (not shown). A short interval later columns 0 through 7 will be activated to light up the appropriate LEDs on row 0. The LED multiplexor will then shut down row 0, activate row 1, and columns 0 through 7 will be activated to light up the appropriate LEDs on row 1. In this manner the screen can be lit to show graphics, text, animations, etc. It is important to note that this row-column (or column-row) addressing technique gives the lowest number of individual input/output electrical control lines to the screen whilst allowing each pixel (LED) to be individually activated.

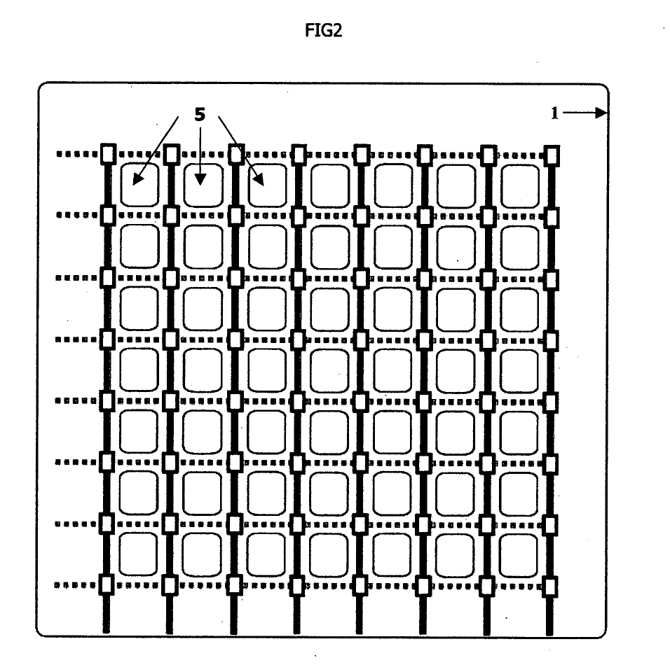

FIG. 2 shows a top view representation of a flexible display screen constructed of a flexible electrical circuit 1 where a series of holes 5 have been cut through the flexible circuit board to give it greater flexibility.

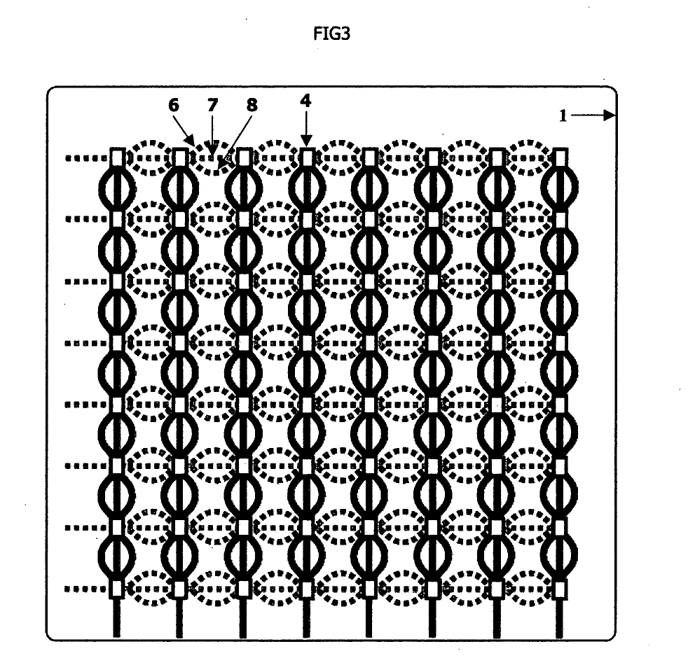

FIG. 3 shows a top view representation of a flexible display screen constructed of a flexible electrical circuit 1 where multiple electrical traces 6, 7, and 8 are used between each LED 4 on the display to act as row and/or column traces. Continual flexing of electrical traces can lead to failures and so the use of two or more electrical traces allows one or more traces to fail but still allow for correct circuit operation. This gives greater reliability to the electrical connectivity.

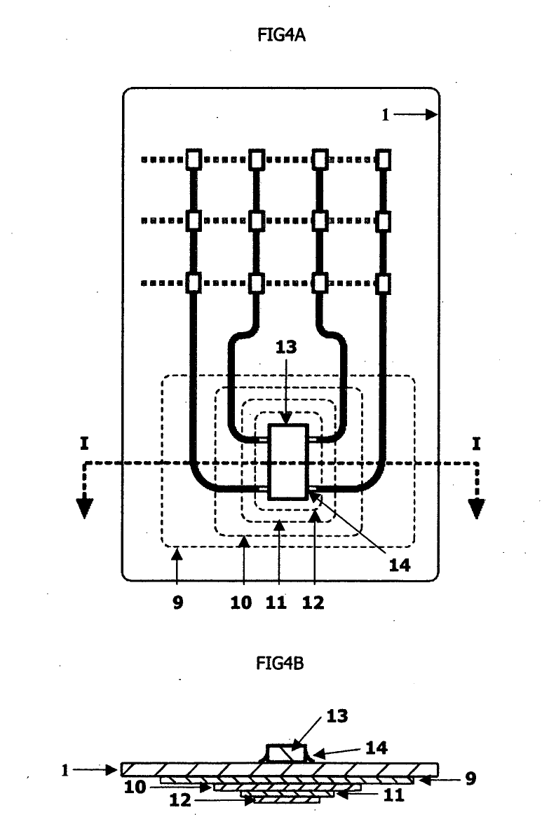

FIG. 4A shows a top view representation of a flexible display screen constructed of a flexible electrical circuit 1 where multiple stacked layers of flexible materials 9, 10, 11, and 12 can be arranged underneath, on top, and/or around the electronic components 13. These stacked layers distribute any stresses caused by flexing of the screen away from the sensitive electromechanical joint areas 14 giving greater reliability to the overall flexible display screen.

FIG. 4B shows a cross-section on I-I of FIG. 4A.

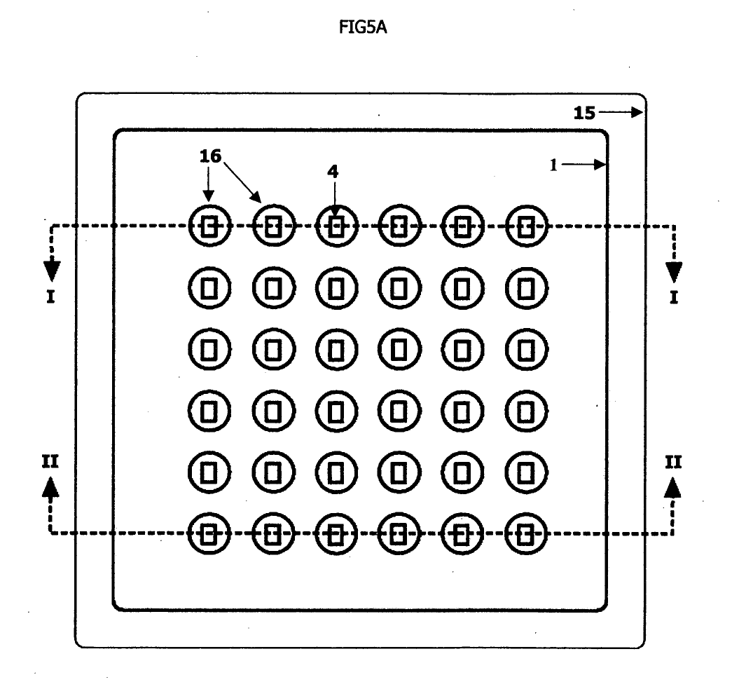

FIG. 5A shows a top view representation of a flexible display screen constructed of a flexible electrical circuit 1 that has been coated and/or molded with a protective, flexible material 15. This serves to waterproof the electrical components and also provide for lenses 16 to be formed above the LEDs 4.

FIG. 5B shows a cross-section on I-I of FIG. 5A where the coating material has been formed into convex lens shapes 17 above each LED 4.

FIG. 5C shows a cross-section on II-II of FIG. 5A where the coating material has been formed into concave lens shapes 18 above each LED 4.

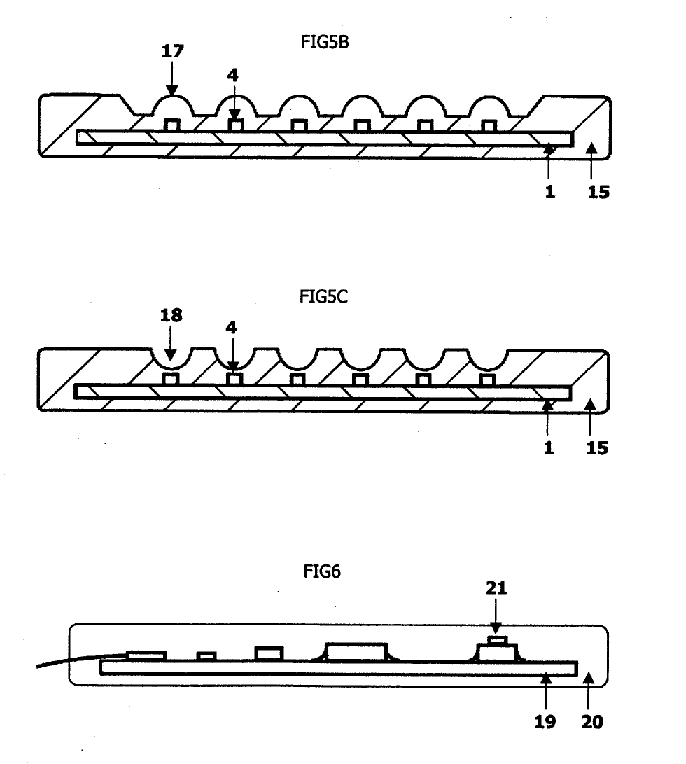

FIG. 6 shows a side view representation of a flexible electrical circuit arrangement 19 where a protective, flexible material 20 is used to cover momentary electrical push buttons 21 fixed to the electrical circuit 19 allowing the button assembly to remain operational when pushed from above while still maintaining a waterproof seal around the button circuit.

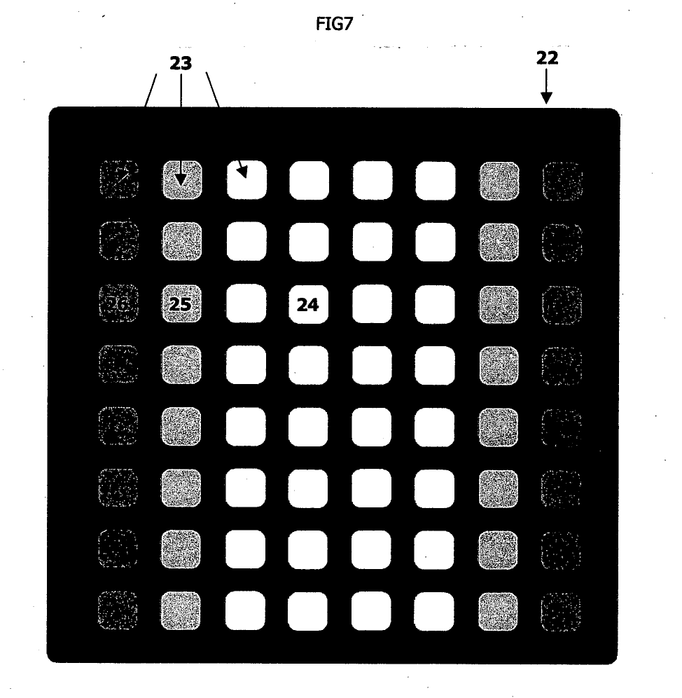

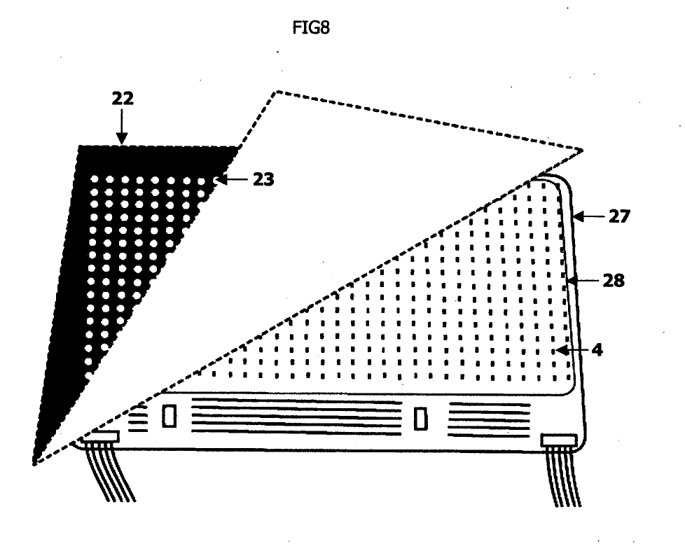

FIG. 7 shows a top view representation of a patterned cover material 22 that can be placed over the flexible display screen. This covering can have individual areas marked 23 where the pixels of the screen lie underneath and shine through. White colored areas 24 of the cover material 22 allow most light to shine through. Shaded areas 25 and 26 allow less light to shine through. The cover material 22 can be made of cloth where the weave of the cloth is used to diffuse and/or scatter the light passing through from underneath. A densely woven fabric of high thread count allows for more diffusion than a loosely woven fabric of low thread count. By using different colored inks on pixel areas 24, 25, and 26, the patterned cover can be used as a color filter for the lights beneath. By using phosphorescent and/or luminescent dyes and pigments on pixel areas 24, 25, and 26, the patterned cover can be used to excite higher wavelengths of light from the dye, which is then emitted outward from the cloth toward the viewer.

FIG. 8 shows a perspective view representation of a flexible display screen 27 overlaid with a patterned cover material 22. Each LED 4 in the row-column display structure is aligned with pixel areas 23 of the patterned cover layer. An intermediate layer 28 is used to attach the display screen to the patterned cover.

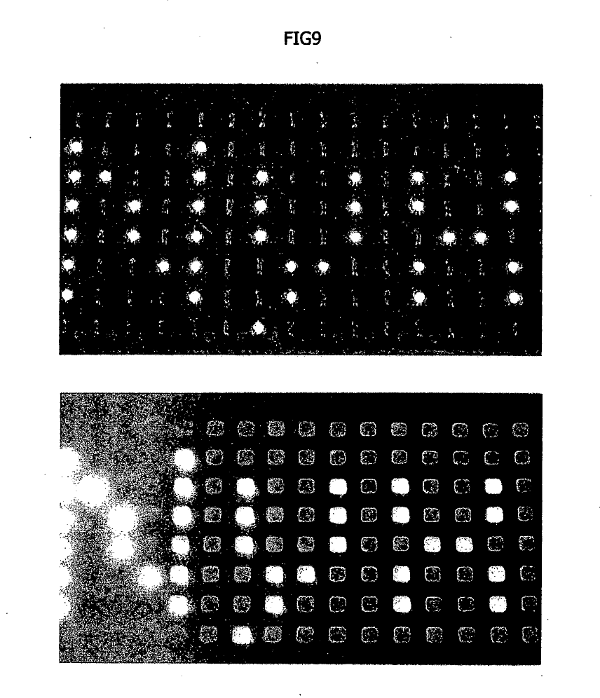

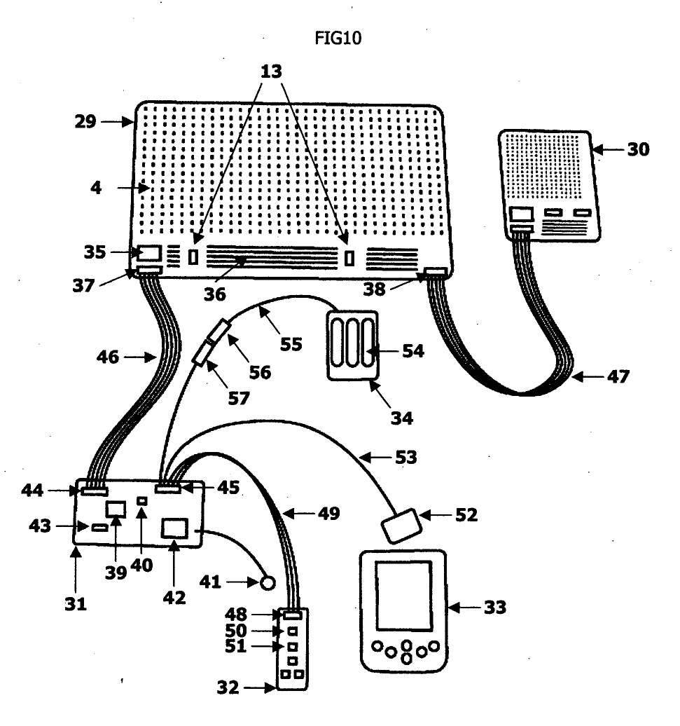

FIG. 9 shows two top view photographs of a flexible display screen. The upper photograph shows a flexible display screen with the word ‘Nyx’ Illuminated. The lower photograph shows the same flexible display screen overlaid with a patterned cover material to give increased diffusion of the pixels.

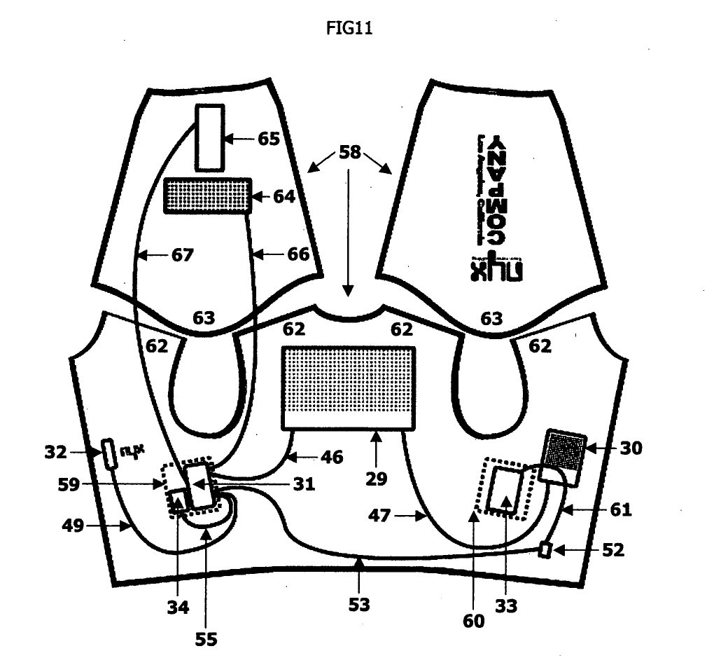

FIG. 10 shows a perspective view representation of two flexible display screens 29, 30 and associated control circuits 31, 32, 33 and power supply 34. Each display screen 29 & 30 consists of flex circuit, light emitting diodes 4 (LEDs), electrical traces, electrical vias, LED mulitplexors 13, termination resistors and capacitors 35, interconnect bus structure 36, and interconnect electrical/mechanical connectors 37 & 38. All these components are encased in a flexible transparent material. A control circuit 31, consists of a microcomputer unit 39 (MCU), momentary switch 40, microphone 41, microphone amplifier circuit 42, RS232 communications chip 43, interconnect electrical/mechanical connectors 44 & 45, all encased in a flexible transparent material. The MCU 39 sends out electrical signals to the connector 44, and along a series of separate interconnecting cables 46 to the flexible display 29. The electrical signals pass along the Interconnect bus structure 36 to the LED multiplexors 13 which light up the LEDs 4. The electrical signals are prevented from echoing back along the bus structure by use of termination capacitors and resistors 35. Electrical signals leave the display 29 through an electrical/mechanical connector 38, to a series of separate interconnecting cables 47 to the flexible display 30. The electrical signals are delivered to the muliplexors in a similar manner described for display 29.

The MCU circuit 31 may communicate with other circuits 32 and 33. Connectors 45 and 48 and a series of separate cables 49 make the electrical connection between circuit 31 and circuit 32. Circuit 32 is a set of momentary electrical push button switches used to control the display screen visuals through selection of appropriate software resident within the MCU 39. Switches 50 and 51 control the gain of the microphone amplifier circuit 42 through use of a digital potentiometer circuit. The output of the microphone amplifier circuit 42 is fed to the analog-to-digital (ADC) input of the MCU 39.

Connectors 45 and 52 and a series of separate cables 53 make part of the electrical connection between circuit 31 and circuit 33. A separate set of connecting cables from connector 52 to circuit 33 is not shown here. Circuit 33 is a personal digital assistant (PDA) used to control the display screen visuals through selection of appropriate software resident within the MCU 39. It may send and receive digitally encoded information to/from the MCU circuit 31 via the RS232 Integrated circuit 43. An infra-red transceiver can be inserted into connector slot 52 to allow the PDA 33 and MCU circuit 31 to communicate via wireless infra-red signaling. A Bluetooth radio transceiver can be inserted into connector slot 52 to allow the PDA 33 and MCU circuit 31 to communicate via wireless radio signaling.

Electrical power is supplied to circuits 29, 30, 31, and 32 by the battery pack 34 and batteries 54. The power is connected through multi-core cable 55, connectors 56 & 57, to connector 45 on MCU circuit 31 The power is then distributed to the remaining circuits through the series of separate cables 46, 47, and 49. The battery pack 34 may be removed by disconnecting connectors 56 and 57. FIG. 10 shows flexible display screens 29 and 30 as physically separate from control circuits 31 and 32 and power supply 34. Other implementations may have some or all of the functionality of circuits 31, 32, and 34 incorporated into a single flexible display screen circuit.

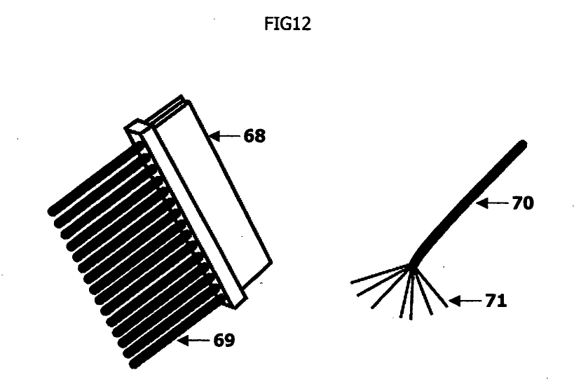

FIG. 11 shows a top view representation of the cloth patterns required for a jacket torso and arms 58. Flexible display screen 29 is fixed in position on the back of the jacket as shown. Flexible display screen 30 is fixed in position on the front right hand side of the jacket as shown. Circuit 32 and connector 52 are fixed in position on the left hand side and right hand side of the jacket respectively as shown. Circuit 31 is positioned within the left hand side inside pocket 59 of the jacket along with the battery pack 34 as shown. PDA circuit 33 is positioned within the right hand side inside pocket 60 of the jacket as shown. All circuits are connected together with a series of cables 46, 47, 49, 53 and multi-core cable 55. An additional connector and multi-core cable 61 is shown here to connect the PDA circuit 33 to the connector 52 and hence the MCU circuit 31.

When a jacket pattern is sewn together at the shoulders 62 and arms 63 it takes on a non-flat three-dimensional shape, typically curved in many areas. This shape will change as the jacket is donned and removed, and as the jacket wearer moves about. The flexible display screens 29 and 30 allow for contouring to these changing curves as the jacket shape changes. The interconnecting cables 46, 47, 49, 53 and multi-core cable 55 allow the circuits 29, 30, 31, 32, 33 and 34 to move relative to each other with ease preventing the jacket cloth from draping awkwardly.

An additional flexible display screen 64 is shown along with an additional set of momentary switches 65. These two circuits are connected to the MCU circuit 31 via cables and connectors 66 and 67 respectively (not all cables are shown). These two additional circuits show how display screens and interactive switches may be placed on the arms of a jacket and these can be used as a method for inputting alpha-numeric characters into the MCU circuit 31 rather than using the PDA circuit 33.

FIG. 12 shows a perspective view representation of a snap fit connector 68 and interconnect cables 69. The interconnect cable is covered with a waterproof coating 70. Each interconnect cable is made of multiple wire strands 71 to give greater flexibility and drape to the Interconnects when used as part of flexible display screen assembly.

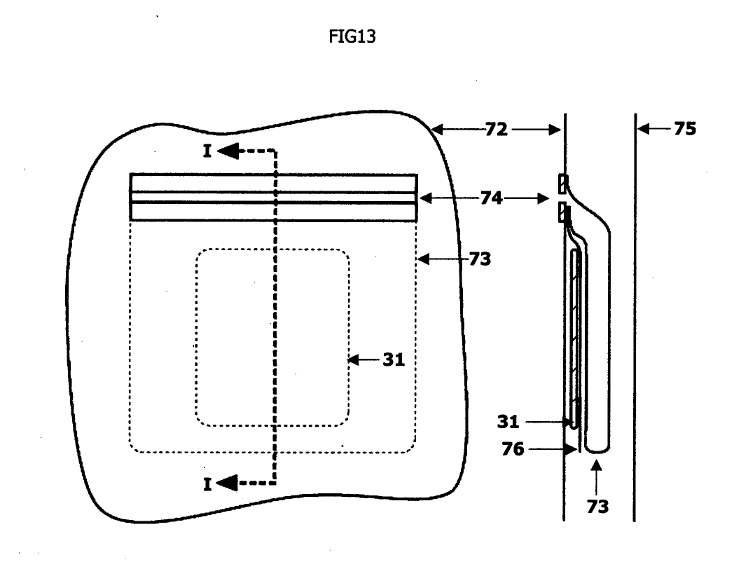

FIG. 13 shows a top view representation of a jacket inside lining 72, inside pocket 73, pocket opening 74, and MCU circuit 31. A cross section view of the pocket along I-I is also shown with inner jacket lining 72 and outer jacket material 75. It can be seen that MCU circuit 31 is attached to an individual flap 76 separate from the pocket assembly 73. This allows the combined MCU circuit 31 and flap 76 to drape within the jacket lining without being visible to the wearer. When the pocket is used any horizontal force exerted on the flap 76 and MCU circuit 31 will push these components away from the pocket. If the MCU circuit 31 were attached directly to the pocket lining 73, use of the pocket can cause the MCU circuit 31 to become detached from the pocket lining 73.

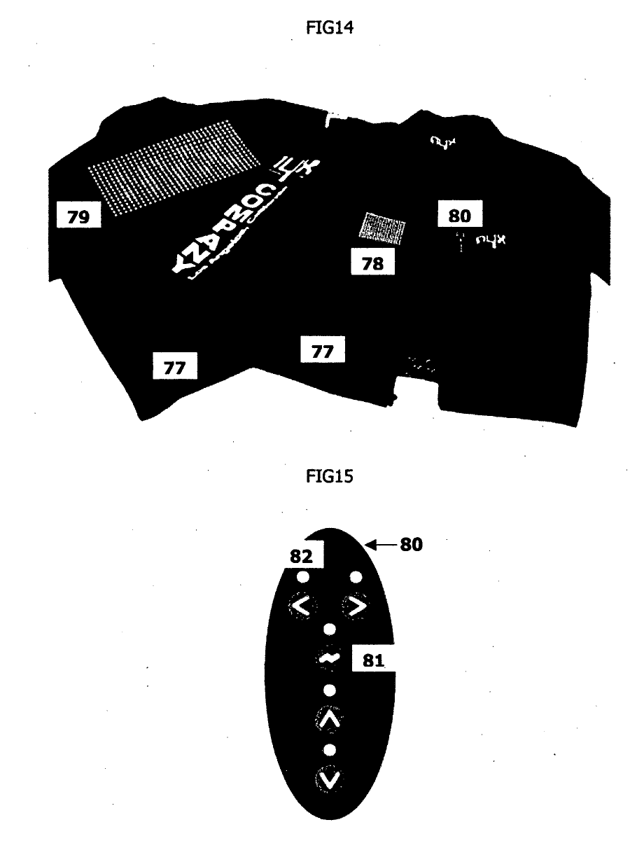

FIG. 14 shows a photograph of an illuminated jacket 77 using a front 78 and rear flexible display screen 79 and associated components. Region 80 has a momentary electrical switch button circuit 32 attached underneath the cloth allowing the switches to be operated from outside the jacket.

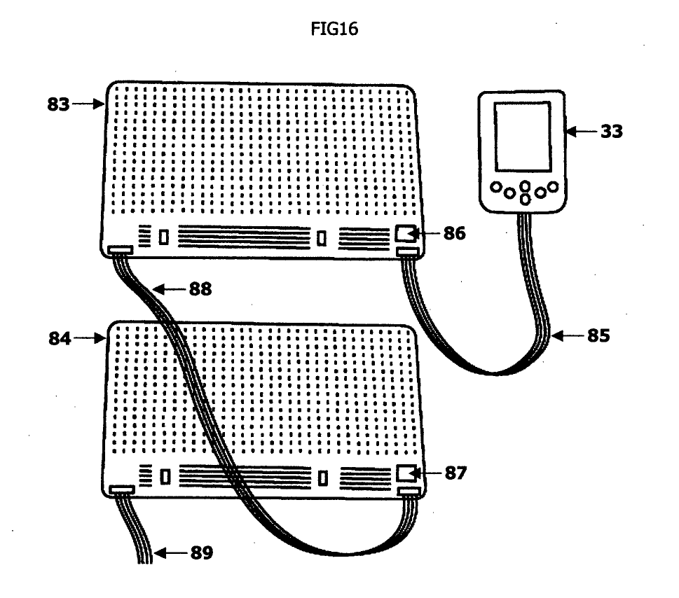

FIG. 15 shows a top view representation of the region 80 that indicates the positions of momentary switches underneath the jacket cloth. The graphics, shading, and colors 81 are achieved through dye and pigmenting of the cloth. The white areas 82 allow Illuminations to shine through to give a visual indication of when a switch has been pressed.

FIG. 16 shows a perspective view representation of two flexible display panels 83 and 84 and associated components. Using a Palm Pilot 33, or other digital controller, an RS232 digital signal is sent to the first panel 83. A wired connection 85 between PDA and first panel 83 is shown here. The digital signal is received on RS232 port 1 of the MCU 86. The digital signal is then relayed out RS232 port 2 of the MCU 86. This digital signal is received on RS232 port 1 of the MCU 87 via the interconnecting cable 88. The digital signal is relayed out RS232 port 2 of the MCU 87 to the next panel in the chain via cable 89. In this manner two or many panels may be linked to form larger area displays.

What is claimed is:

1) A two dimensional flexible display screen comprising:
electrical flex circuit for interconnections;
surface mount light emitting electrical diodes acting as emissive pixels;
surface mount electronic components for controlling said pixels;
a) said combination of electrical flex circuit, surface mount light emitting diodes, and surface mount electronic components to control the pixels in a row-column matrix such that each pixel can be individually activated;
b) said two dimensional display matrix being at least m by n pixels in size where m, n are integers, and m or n is greater than 1;
c) said two dimensional display to permit flexing in a third dimension of space and,
d) said display to permit, but not be restricted to, representations of alpha-numeric characters.

2) The flexible display screen according to claim 1 wherein one or more holes formed in the layers of the flexible display screen where no components, electrical vias, or electrical traces are present, allow for greater flexibility of the overall circuit.

3) The flexible display screen according to claim 1 wherein one or more of said interconnections includes redundant conductors.

4) The flexible display screen according to claim 1 including means for stiffening selected portions of the sheet form body adjacent, on top, or below the electrical traces, light emitting pixels, and/or electronic components.

5) The flexible display screen according to claim 1 wherein silicone (or other suitable material) is used to coat electrical flex circuits giving increased mechanical strength of the overall assembly and its individual elements, whilst allowing the combined silicone/electrical assembly to remain flexible, bendable, and waterproof.

6) The flexible display screen according to claim 1 wherein silicone (or other suitable material) is used to form columns over LEDs or other light emitting or reflecting elements, that can be shaped to act as refractive lenses to focus or defocus the emitted or reflected light.

7) The flexible display screen according to claim 1 wherein silicone (or other suitable material) placed on top of the light emitting electrical circuit acts as an optical diffuser for the LEDs or other light emitting elements.

8) The flexible display screen according to claim 1 wherein silicone (or other suitable material) is used to cover momentary electrical push buttons fixed to the electrical flex circuit allowing the button assembly to remain operational when pushed from above while still maintaining a waterproof seal around the button circuit.

9) The flexible display screen according to claim 1 wherein the use of a digital variable potentiometer and momentary electrical push buttons as part of a variable amplification circuit can be coated with silicone (or other suitable material) so as to remain waterproof and yet retain variable potentiometer control through the momentary electrical push buttons.

10) The flexible display screen according to claim 1 wherein cloth (or other suitable material) placed on top of the light emitting pixels acts as an optical diffuser for the LEDs or other light emitting elements; cloths of different weave and thread count may be used to achieve different diffusion patterns.

11) The flexible display screen according to claim 1 wherein cloth (or other suitable material) placed on top of the light emitting pixels can selectively control the transmission of illuminations through the cloth; cloths of different weave and thread count (or other suitable material) may be used to achieve different transmissions values.

12) The flexible display screen according to claim 1 wherein colored and non-colored regions of cloth (or other suitable material) placed on top of the light emitting pixels can selectively control the transmission of illuminations through the cloth.

13) The flexible display screen according to claim 1 wherein colored and non-colored regions of cloth (or other suitable material) placed on top of the light emitting pixels selectively define areas where a pixel of light could be expected to appear.

14) The flexible display screen according to claim 13 wherein the colored and non-colored regions of cloth can be designed as any graphical shape such as heart shapes, Irish clover, Christmas holly etc.

15) The flexible display screen according to claim 1 wherein colored, phosphorescent, or luminescent ink on cloth (or other suitable material) can selectively change the perceived color emitted through the cloth from the light emitting pixels beneath.

16) The electrical circuit arrangement according to claim 8 wherein the location and function of momentary control button switches attached underneath a piece of cloth (or other suitable material) are indicated with graphical shapes and colors inked, dyed, or laminated onto the surface of the cloth above the control button switches visible to the user and that said graphical indicators can also be used to define active pixel areas on the cloth adjacent to the buttons where illuminations shine through the cloth from an LED connected to the switch circuit beneath indicating when a switch has been activated.

17) The flexible display screen according to claim 1 wherein silicone (or other suitable material), fastener snaps, sewing thread, hook and loop fasteners, adhesives, pouches, pressure sensitive tape, or other means may be used to keep the flexible display screen in contact with the cloth material.

18) The flexible display screen according to claim 1 wherein silicone (or other suitable material) is used to form columns over LEDs or other light emitting or reflecting elements and other electrical components such that air pockets are created around the columns between the circuit and the layer of cloth attached to the top of the columns allowing for greater durability of the display screen structure by providing cushioned impact resistance.

19) The flexible display screen according to claim 1 wherein cloth placed on top of the electrical circuits has the cloth aligned with the electrical circuits so as to minimize stiffness of the assembly in the desired orientation of flexing.

20) The flexible display screen according to claim 1 having:
a) a means for sensing environmental stimuli and transmitting related electrical signals to the microcomputer unit;
b) a pattern generator within the microcomputer unit causing said display screen to respond to the stimuli;
c) a sensor selected from the list consisting of, but not limited to, an audible sound sensor, an inaudible sound sensor, a visible light sensor, an invisible light sensor, a pressure sensor, a temperature sensor, or a gas sensor.

21) The flexible display screen according to claim 1 wherein use of a microcomputer unit as an interface between a PDA (personal digital assistant) or other external computing device, such as a wireless cell-phone, permits the flexible display screen to respond to external control.

22) The flexible display screen according to claim 21 wherein use of a microcomputer unit within an individual screen permits a unique identifying number to be assigned to an individual screen such that each individual screen within proximity to a group of multiple individual screens can uniquely respond to external control.

23) The flexible display screen according to claim 21 wherein use of a microcomputer unit within each individual screen permits all individual screens within proximity to each other to simultaneously respond to external control from a single transmission source.

24) The flexible display screen according to claim 1 additionally comprising:
a multiplicity of separate electrical circuits all electrically interconnected with flexible cable wire;
a) said arrangement to allow for electrical operation of the flexible display screen (or screens) and separate circuits when placed and attached onto, below, and/or within the surface of a non-flat three dimensional space;
b) said arrangement to allow for electrical operation of the flexible display screen (or screens) and separate circuits as they move relative to each others position on the said surface as said surface varies in time;
c) said flexible display screen (or screens) to allow for flexing in three dimensions of space as the said surface the said display screen is attached to, varies in time.

25) The flexible display screen arrangement according to claim 24 wherein multiple individual cables, each individual cable made of multiple wire strands, and each individual cable with protective outer coatings to prevent electrical shorting, are used to electrically connect separate electrical circuits within an item of clothing allowing the cabling to hang and drape within the garment and so remain hidden from outside view.

26) The flexible display screen arrangement according to claim 24 wherein the number of individual cables required to electrically connect separate electrical circuits can be reduced by using digitally coded data carried on only one or two Interconnect cables using, for example, an RS232 protocol or other such technical specification, reducing cost, weight, and mechanical complexity of the overall arrangement.

27) The flexible display screen arrangement according to claim 24 wherein use of wireless radio technology to transmit digitally coded data between separate electrical circuits can reduce the number of individual interconnect cables, reducing cost, weight, and mechanical complexity of the overall arrangement.

28) The flexible display screen arrangement defined In claim 24 that allows tiling of multiple display screen arrangements together to form smaller parts of an overall larger screen area.

29) A flexible flap attached to an article of clothing along one edge of the flap so that when attached to an electronic circuit board permits the combined flap and circuit board combination to hang and move freely about the point within the article of clothing that the flap is attached to.

30) A flexible display screen arrangement wherein two or more screens are used within an article of clothing, at least one screen on or near the front of the clothing and at least one screen on or near the rear of the clothing, the front screen allowing the user to monitor what is being displayed on the rear screen.
